(19) United States
(12) Patent Application Publication
(10) Pub. No.: US 2024/0380363 A1
(43) Pub. Date: Nov. 14, 2024

(54) Heating and/or cooling module for a photovoltaic panel

(71) Applicant: Viridi Holding B.V., Soest (NL)

(72) Inventor: Johannes Petrus Pollemans, Soest (NL)

(73) Assignee: Viridi Holding B.V., Soest (NL)

(21) Appl. No.: 18/564,431

(22) PCT Filed: May 20, 2022
(86) PCT No.: PCT/NL2022/050277

§ 371 Date: Nov. 27, 2023

(30) Foreign Application Priority Data
May 31, 2021 (NL) 2028343

(51) Int. Cl. H02S 40/42; B32B 3/08; B32B 3/26; B32B 3/30; B32B 5/02; B32B 5/26; B32B 27/12; B32B 37/10; B32B 37/24; F24S 10/50; F24S 20/00; F24S 70/60; F24S 80/30; F24S 80/70; H02S 40/44

(52) U.S. Cl. CPC H02S 40/425; B32B 3/08; B32B 3/266; B32B 3/30; B32B 5/02; B32B 5/26; B32B 27/12; B32B 37/10; B32B 37/24; F24S 10/501; F24S 70/60; F24S 80/30; F24S 80/70; B32B 2037/243; B32B 2255/02; B32B 2255/26; B32B 2274/00; B32B 2305/18; B32B 2307/7265; B32B 2457/12; F24S 2020/17; H02S 40/44

(57) ABSTRACT

A heating and/or cooling module for a photovoltaic panel includes a 3D-textile core having a first main surface and a second main surface parallel thereto, together enclosing a volume, and a plurality of piles attaching the main surfaces to each other. An inlet is provided into the volume and an outlet out of the volume, so that a fluid can flow from the inlet to the outlet through the volume. At least one of the first main surface and the second main surface includes a plastic sealing layer, and that the first and second main surface are connected to each other by melting of the plastic sealing layer. A method of manufacturing such a module and a photovoltaic panel with such a module.

The invention relates to a heating and/or cooling module for a photovoltaic panel, arrangeable on e.g. a back of the photovoltaic panel, said cooling module comprising
a 3D-textile core, having:
   a first main surface and a second main surface extending substantially parallel to the first main surface at a distance thereof, the first main surface and the second main surface enclosing a volume, and
   a plurality of piles attaching the first and second main surfaces to each other; and
an inlet into the volume and an outlet out of the volume, so that a fluid can flow from the inlet to the outlet through the volume, thereby absorbing heat from or discharging heat to the photovoltaic panel and/or the surroundings through the first main surface.

Such a heating and/or cooling module, which can be used for improving the efficiency of the panel and/or for collecting heat from the panel which can be used elsewhere, is known from WO 2017/072212 A1. Although adequate to some extent, the known module is cumbersome in terms of its construction: in the first place, applying the frame to the core in a sealing manner is troublesome. The connection between the core and the frame has proven unreliable in the sense that it is a source of leaks. In the second place, it has proven difficult to attach the module with the frame to photovoltaic panels, as the presence of the frame presents a non-flat surface for attaching the module to the photovoltaic panel.

The invention has for its object to provide a heating and/or cooling module which is more reliable and/or has a less complex construction and/or which may be more easily attached to a photovoltaic panel.

In accordance with the invention, this is achieved by a heating and/or cooling module according to the preamble of claim 1, wherein at least one of the first main surface and the second main surface comprises a plastic sealing layer, and wherein the first and second main surface are connected to each other by melting of the plastic sealing layer.

By connecting the main surfaces to each other by melting the plastic sealing layer, a particularly reliable seal may be obtained.

The provision of a plastic sealing layer may have significant further advantages. In particular, by using a fusible plastic, such as a thermoplastic, it may prove much easier to attach the sealing layer to the 3D-textile. Moreover, it may no longer be necessary to provide a frame along all the edges for this purpose as was disclosed in WO 2017/072212 A1. This may simplify production of the module, and provide a more reliable module. More reliable herein may mean that the chances of the module leaking are reduced. Additionally, the module without the frame may be easier to attach to a photovoltaic panel.

The heating and/or cooling module presented herein can be used for a photovoltaic panel, also referred to as a solar panel. Such a panel typically comprises a front, configured to absorb radiant light and heat from the sun, and a back, which typically is inactive compared to the front and/or is typically oriented for receiving no or a minimal amount of sun light and heat compared to the front. The module may be attached to the back of the photovoltaic panel in order to cool it or in order to heat it. By cooling the panel, the module absorbs heat which may be used for instance for heating houses. As such, the module may be used to convert a photovoltaic panel to a photovoltaic thermal panel, i.e. PV to PVT.

It is possible that the first and the second main surface each comprise a plastic sealing layer, wherein the first and second main surfaces are connected to each other via their sealing layers.

By connecting the first and second main surface to each other via their sealing layers, a particularly reliable seal can be made between the two.

In an embodiment of the module, the connection between the first and second main surface is made along an edge of the first and second main surface.

By providing the connection at the edge, no frame or edging needs to be provided along said edge for sealing the surfaces to each other. This reduces complexity and/or increases reliability.

In another embodiment of the module, the first and second main surface are connected to each other at an outer edge.

As such, the reliable connection between the surfaces may be used to seal volume defined by the main surfaces off from the outside world, thereby reducing leaking of said sealed volume.

In yet another embodiment of the module, the 3D-textile core is provided with a through opening extending through the first and second main surface for admitting an element, e.g. an element at the back of the photovoltaic panel, for instance an optimizer thereof, thereby defining an inner edge in the first and second main surface, wherein the first and second main surface are connected to each other at the inner edge.

By connecting the main surfaces together along the inner edge, especially when done by melting the sealing layer or layers of the main surfaces, it is possible to provide the through opening in a variety of places and in a variety of sizes. As such, the module can be made suitable for different kinds of photovoltaic panels, so that the module becomes more versatile.

The element admitted through the through opening is typically an element which is fixed to and/or part of the photovoltaic element, and may for instance comprise an optimizer of the panel.

In particular, the plastic of the sealing layer may comprise a thermoplastic. Thermoplastics are preferred due to their fusible properties. As an alternative, a thermosetting plastic may be used that can be melted once to provide the connection.

In particular, the plastic may be thermoplastic polyurethane. Very favorable results have been achieved by using thermoplastic polyurethane, firstly because it is relatively easy to apply to the 3D-textile, secondly because it provides excellent sealing capabilities, and thirdly because it can be melted to interconnect the main surfaces. Additionally, thermoplastic polyurethane has been found capable of withstanding temperatures to which the module will be exposed, in particular when the module is connected to the back of a photovoltaic panel.

In any case, the two main surfaces may be connected to each other via the plastic sealing layer(s) by squeezing the main surfaces together before and/or during and/or after melting the plastic sealing layer(s).

The module may have at least one of the inlet and the outlet arranged in one of the first and second main surface. By providing the inlet and/or outlet in the main surface, the edges remain free of the inlet and/or outlet. Accordingly, the main surfaces may be interconnected, preferably directly via their respective sealing layers, near the edges.

The inlet and/or outlet may be embodied by a through hole in at least a respective one of the first main surface or the second main surface.

The module may further comprise an adapter connected to the inlet and/or outlet, the adapter being configured for connecting a conduit thereto.

By providing an adapter, it may be relatively easy to install the module by connecting conduits to the inlet and/or outlet of the module. Further, when an adapter is used to connect to the inlet/outlet, a reliable connection, which is thus not likely to leak, between adapter and main surface may be provided, for instance at the factory. Afterwards, conduits can be connected to the module by relatively unskilled workers, for instance at a place of use.

In one embodiment of the module, the module comprises multiple inlets or outlets and at least one rigid flow element comprising the adapter and connecting the adapter to multiple inlets or outlets respectively.

Using the rigid flow element, fluid may be divided across several inlets, or combined from several outlets. This allows the flow to be distributed over the module, preferably substantially evenly, which aids in absorbing energy from the photovoltaic panel.

The rigid flow element may be attached to a main surface of the module, for instance at a, possibly small, distance from an edge thereof. Accordingly, the edge may be left free of inlets and outlets so that it may be sealed reliably. Nevertheless, by arranging the flow element, and thus the inlets and outlets close to the edge, a large portion of the module may be used for flowing liquid therethrough.

The flow element may be a solid component with a channel defined therein. The channel may connect to the inlets or outlets. The adapter may connect to the channel. Such a flow element is relatively easy to manufacture and relatively easy to attach to one of the main surfaces of the module.

Alternatively, the rigid flow element may be a hollow profile. The hollow profile may be provided with openings connecting to the inlets or outlets, and may be fitted with the adapter. The hollow profile has the advantage that it requires less material than a solid flow element.

In order to reliably connect the hollow profile to one of the main surfaces, the hollow profile may comprise at least one hollow protrusion extending through an inlet or outlet. Using the hollow protrusion, a relatively large surface area is created for connecting the flow element to the main surface. This relatively large surface may be used to reliably connect the two components together.

In yet another embodiment of the module, at least one of the first and second main surface comprises a textile layer and a coating forming the sealing layer, wherein optionally the coating layer protrudes at least partly into the textile layer.

The textile layer(s) can be created by knitting, weaving or some other kind of fabrication for making a 3D-textile. Accordingly, the first main surface and/or the second main surface may comprise a woven, knitted or non-woven textile layer. The textile layers may comprise threads that continue to form the piles in between the main surfaces. Using the coating, which may be applied after fabrication of the 3D-textile, the main surfaces can be sealed. It is especially advantageous if the coating protrudes at least partly into the textile layer, because this may create a relatively strong mechanical bond between the coating and the textile layer. It may further be advantageous if the coating completely covers the textile layer, so that no parts of the textile layer protrude from the coating layer. This may create a closed encapsulation around the textile layer, which is relatively unlikely to leak. Typically, the textile layers of the first and second main surface face each other.

In order to prevent leaks, the coating may be water impermeable, or at least substantially so. Water impermeable may herein mean that no leaks when the coating is subjected to normal use conditions. As an example, such conditions may include a fluid pressure of up to ca. 2 bar above atmospheric pressure.

The first and second main surfaces may be connected directly to each other, optionally by their respective sealing layers. This may aid in achieving a module with a particular reliable seal. Moreover, no further materials may be needed to connect the main surfaces together, which simplifies production.

In order to provide a connection between the main surfaces, at least an end zone of a sealing layer of at least one of the first main surface and the second main surface may extend towards the other of the first main surface and the second main surface. Correspondingly, the main surfaces are closer to each other at the end zone, making it easier to connect the main surfaces together. The main surfaces may be pressed towards each other, or even together, in order to make one or both of the main surfaces extend towards the other.

Said sealing layer of the at least one of the first main surface extending towards the other of the first main surface and the second main surface may have an overlength with respect to the textile layer of its respective main surface. Accordingly, said sealing layer may extend beyond the textile layer. The sealing layer may accordingly be used to connect to the other main surface, without the textile interfering at the connection. Such interference, for instance in the form of parts of the textile layer protruding through the sealing layer, could detriment the reliability of the module. As such, the overlength aids in creating a reliable sealing.

Adding an overlength is for instance particularly suitable when the textile layer is coated in a machine direction, for instance over a continuous web of material. In such a case, the overlength can be created relatively easily on transversal sides of the textile layer. If the web is indeed continuous, the web may be separate into module-size portions later.

The sides in the machine direction may therefore not have the desired overlength. It is however possible to find other methods of adding sealing material for connecting the two main surfaces. One such method is adding a strip of plastic, for instance of the same material as the sealing layer, between the sealing layers of the first and second main surface, connecting the first and second main surface to each other.

Accordingly, the two main surfaces may be melted for connecting them to the strip of material, and pressed together, in order to create a seal.

At least some of the piles may run through the strip, thereby mechanically strengthening the module at the position of the strip. Nevertheless, the strip is preferably arranged so as to cover all piles as seen from outside the module, since this increases reliability.

As a further method of adding sealing material, two flanges may be arranged on the outsides of the first and second main surfaces along the edge, the two flanges being interconnected. This configuration leads to a relatively large amount of available material, thereby contributing to rendering a relatively reliable sealing of the main surfaces to each other.

For increasing reliability, the two flanges may be part of a single profile, which is optionally U or V-shaped in cross section.

The profile can be made from a flexible or rigid polymer, such as polyurethane. In particular, polyurethane is considered since it may adhere well to the sealing layers. Thermoplastic polyurethane may be useful for allowing to shape the profile and to seal the module in different manufacturing steps due to its ability to be softened repeatedly.

The two flanges may extend from a conduit extending along the edge, so that the conduit can be used for transporting fluid across the length of the edge.

Different edge zones of the module may be connected using different methods. In particular, it is envisioned along a first edge zone the main surfaces may be connected directly to each other, for instance by their respective sealing layers. In particular, this could be done using the overlength introduced above.

Along another edge zone, the main surfaces could be connected using the added strip, or using flanges.

Such a module may be manufactured with relative ease, as the connection along the first edge zone can be created on transversal sides of the module when using a continuous process performed in a machine direction, whereas the connection along the second edge zone can be created on the other sides, for instance after cutting the module to size.

As such, the first and second main surfaces may be substantially rectangular, and the first and second edge zones are oriented substantially perpendicular to each other.

The invention also relates to a method of manufacturing a heating and/or cooling module for a photovoltaic panel, which is arrangeable on e.g. a back of the photovoltaic panel, the method comprising:
a) providing a 3D-textile having a first main surface and a second main surface extending substantially parallel to the first main surface at a distance thereof, and a plurality of piles attaching the first and second main surfaces to each other, at least one of the first main surface and the second main surface comprising a sealing layer:
b) performing a sealing step so that the two main surfaces enclose a volume, comprising the steps of:
   b1) heating the sealing layer of the at least one of the first main surface and the second main surface, and
   b2) squeezing the first main surface and the second main surface towards each other at the location of the sealing layer; and
c) providing an inlet and an outlet into the volume.

By heating the main surfaces and by squeezing them a reliable connection may be made between the two main surfaces. The heating and squeezing steps may be performed at least partly simultaneously. Heating the sealing layer(s) may be construed as heating at least a part thereof.

The method may be used to obtain a module as described above, having any of the features and their corresponding advantages, alone or in whatever suitable combination.

In particular, the method may comprise providing the first and second main surface with a coating, wherein in step b) the respective coatings are used to directly attach the first and second main surfaces together.

Accordingly, the coatings can act as the sealing layer(s) creating a reliable connection between the two main surfaces.

The method steps may be performed in any suitable order, e.g. step c) may be performed directly or indirectly after or before step b).

The invention also relates to a photovoltaic panel, provided with a heating and/or cooling module as described above, attached to the back of the photovoltaic panel. The module may be used to heat and/or cool the photovoltaic panel. Collectively, the panel and the module may operate as a PVT-panel.

The invention will be further elucidated with reference to the attached figures, in which:

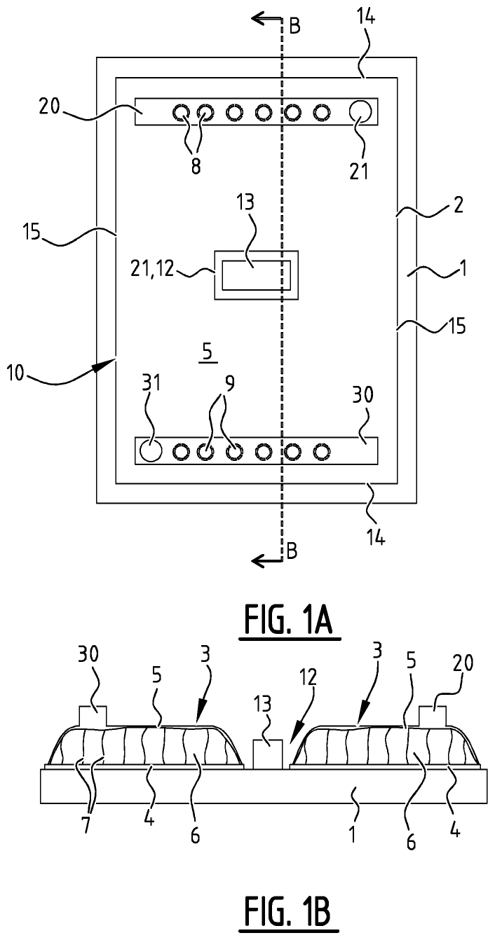

FIG. 1A shows the rear side of a photovoltaic panel to which an embodiment of a module according to the invention is attached;

FIG. 1B shows a cross-section of the panel of FIG. 1A:

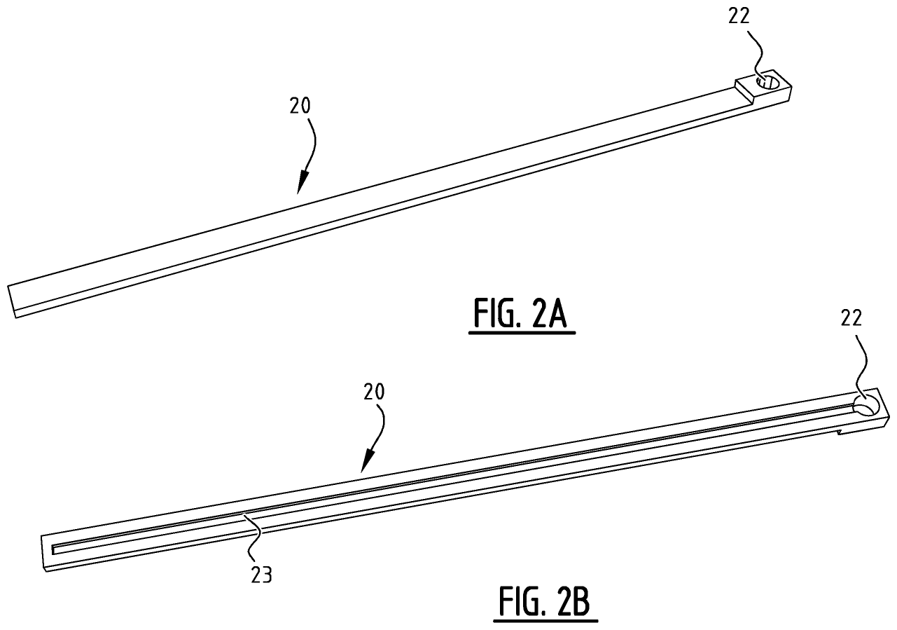

FIG. 2A shows a perspective view of a flow element of the module according to the invention:

FIG. 2B shows a rear perspective view of the flow element according to FIG. 2A.

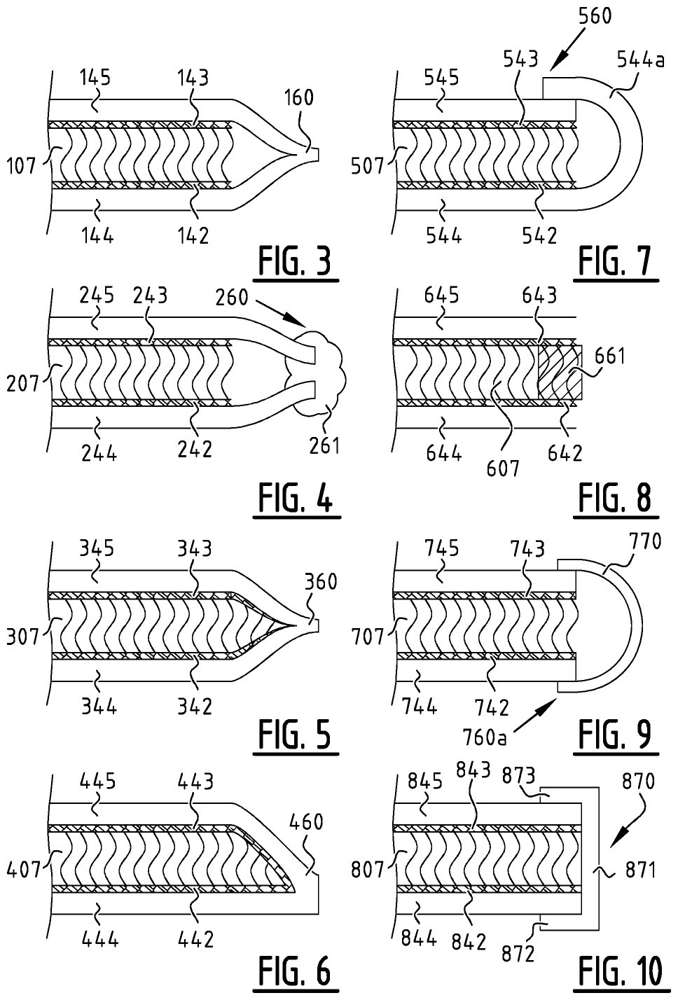

FIG. 3 shows a cross-section of an embodiment of a module according to the invention:

FIG. 4 shows a cross-section of another embodiment of a module according to the invention:

FIG. 5 shows a cross-section of another embodiment of a module according to the invention;

FIG. 6 shows a cross-section of another embodiment of a module according to the invention:

FIG. 7 shows a cross-section of another embodiment of a module according to the invention:

FIG. 8 shows a cross-section of another embodiment of a module according to the invention:

FIG. 9 shows a cross-section of another embodiment of a module according to the invention;

FIG. 10 shows a cross-section of another embodiment of a module according to the invention:

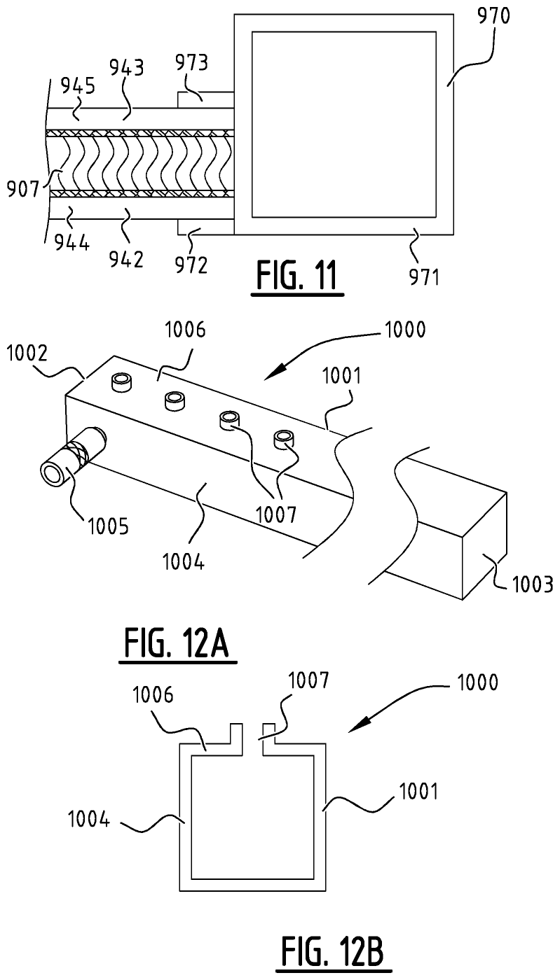

FIG. 11 shows a cross-section of another embodiment of a module according to the invention:

FIG. 12A shows a perspective view of another embodiment of a flow element for a module according to the invention.

FIG. 12B shows a cross-section of the flow element according to FIG. 12A.

The same elements are designated in the figures with the same reference numerals. Corresponding elements of different embodiments are designated with a reference numeral increased by 100 (one hundred).

FIGS. 1A and 1B show a rear view of a photovoltaic panel 1, provided with a cooling module 2. The cooling module 2 comprises 3D-textile core 3. This core 3 has a first main surface 4 and a second main surface 5, which extends substantially parallel to the first main surface 4 at a distance thereof (see FIG. 1B), the first main surface 4 and the second main surface 5 enclosing a volume 6, and a plurality of piles 7 attaching the first and second main surfaces 4, 5 to each other, as well as a number of inlets 8 into the volume 6 and a number of outlets 9 out of the volume 6, so that a fluid can flow from the inlets 8 in the second main surface 5 to the outlets 9, also in the second main surface 5, through the volume 6, thereby absorbing heat from the photovoltaic panel 1 (or vice versa) through the first main surface 4. The first main surface 4 and the second main surface 5 each comprise a textile layer and a plastic sealing layer, formed by a coating layer which is water impermeable (see for example FIGS. 3 to 11), and the first and second main surface 4, 5 are connected to each other by melting of this plastic sealing layer along an outer edge 10 and an inner edge 11, which inner edge 11 is defined by a through opening 12 in the first and second main surface 4, 5 for admitting an optimizer 13 of the photovoltaic panel 1.

The outer edge 10 is rectangular, and comprises two first edge zones 14 and two second edge zones 15, which zones 14, 15 are perpendicular to each other. The second main surface 5 is bent towards the first main surface 4, and these are connected to each other by melting their respective plastic layers at the first edge zones 14, for forming a connection according to FIG. 6. At the second edge zones, the first and second main surface 4, 5 are connected according to a different method, for instance according to FIG. 10.

The module 2 is provided with a first rigid flow element 20, provided with an adapter 21. The adapter 21 is connected to each of the inlets 8 by a channel in the flow element 20 (see FIG. 2B). The module is also provided with a second rigid flow element 30, provided with an adapter 31.

The rigid flow element 20 is shown in more detail in FIGS. 2A and 2B. The rigid flow element 20 is provided with an opening 22. The opening 22 is provided with an internal thread for connecting to adapter 21, which is therefore provided with an external thread. The rigid flow element 20 comprises an elongate channel 23, fluidly connecting the opening 22 with the inlets 8 when mounted on the second main surface 5, such as shown in FIGS. 1A and 1B.

FIGS. 3 to 11 show possible ways in which the first main surface and the second main surface are connected to each other, which in each case comprises a step of melting and pressing at least one plastic part of the module to another part of the module, which is typically also a plastic part. In particular, said plastic part or parts is or are preferably a thermoplastic, more preferably thermoplastic polyurethane, unless mentioned otherwise. It should be noted that these are just exemplary embodiments, and consequently, suitable combination of these types of connections are possible.

In the embodiment according to FIG. 3, the first main surface and the second main surface comprise a first and second textile layer, respectively 142, 143, which are provided with respective first and second water impermeable thermoplastic coating layers 144 and 145, such as layers of thermoplastic polyurethane, which coating layers extend beyond the end of the first and second textile layers 142, 143, and which are bent towards each other, and pressurized and molten, for forming a joint 160. The thermoplastic coating layers 144 and 145 may be partly mixed with the respective textile layers 142, 143.

In the embodiment according to FIG. 4, the coating layers 244, 245 are not directly connected to each other, as is the case in the embodiment according to FIG. 3, but are connected to each other by the injection of an amount of molten plastic 261 between coating layers, 244, 245, resulting in an indirect connection 260.

The embodiment according to FIG. 5 differs from the embodiment according to FIG. 3 in the sense that the coating layers 344, 345 in this embodiment do not extend beyond the end of the first and second textile layers 342, 343. Consequently, the first and second textile layers 342, 343 as well as the piles 307 extending between those, extend up to the joint 360.

The embodiment according to FIG. 6 differs from the embodiment according to FIG. 5 in the sense that only the second main surface 405 is bent towards the first main surface 404, instead of bending both the first main surface 404 and second main surface 405.

The embodiment according to FIG. 7 differs from the embodiment according to FIG. 3 in the sense that the first thermoplastic coating layer 544 has an overlength 544a with respect to the second thermoplastic coating layer 545. This overlength 544a is folded over the second thermoplastic coating layer 545 and sealed thereto by melting of at least one of the layers 544, 545, forming joint 560.

The embodiment according to FIG. 8 differs from the embodiment according to FIG. 4 in the sense that the coating layers 644, 645 do not extend beyond the textile layers 642, 643. Consequently, the injected molten plastic 661 is injected between the textile layers 642, 643 and the coating layers 644, 645 are not bent at their ends.

The embodiment according to FIG. 9 differs from the embodiment according to FIG. 8 in the sense that the end is not closed off by the injection of the material, but that the end is provided with a thermoplastic V-shaped end cap profile 770, which is connected to the coating layers 744, 745 by melting the part of the cap profile 770 adjacent to the coating layers 744, 745, for forming joint 760a, 760b.

The embodiment according to FIG. 10 differs from the embodiment according to FIG. 9 in the sense that the end cap profile 870 is U-shaped, instead of V-shaped, implying that the end comprises a base part 871, with two legs 872, 873, upright from the base part.

The embodiment according to FIG. 11 differs from the embodiment according to FIG. 10 in the sense that the end cap profile 970 is a three-part profile, comprising two plastic and possibly thermoplastic leg parts 972, 973, as well as a profile 971. The leg parts 972, 973 are made of a plastic, such as polyurethane, preferably thermoplastic polyurethane. The profile is made of one or a mixture of thermoplastic polymers, such as acrylonitrile styrene acrylate and/or polyvinyl chloride. The respective leg parts 972, 973 are connected to the coating layers 944, 945 by melting of at least one of the respective legs 972, 973 and the coating layers 944, 945, and are connected to the profile 971 by melting of at least one of the leg parts 972, 973 and profile 971.

In FIGS. 12A and 12B, a different rigid flow element 1000 for use with a module according to the invention is shown. The element 1000 comprises a hollow profile 1001, which is closed at the longitudinal ends of the profile with caps 1002, 1003. Near a first longitudinal end of the element 1000, a first side of the profile 1004 is provided with an inlet 1005, for connection to a conduit. A second side 1006, perpendicular to the first side 1005, is provided with a plurality of hollow protrusions 1007, designed for connecting to inlets of a module according to the invention.

Although the invention is elucidated above on the basis of a number of specific examples and embodiments, the invention is not limited thereto. Furthermore, the module according to the invention is not restricted to use in combination with photovoltaic panels, but may for instance also be used in combination with other devices which produce heat which would otherwise be wasted. Consequently, the scope of the invention is defined by the following claims.

1-32. (canceled)

33. A heating and/or cooling module for a photovoltaic panel, arrangeable on a back of the photovoltaic panel, said heating and/or cooling module comprising:
a 3D-textile core, having:
a first main surface and a second main surface extending substantially parallel to the first main surface at a distance thereof, the first main surface and the second main surface enclosing a volume, and
a plurality of piles attaching the first and second main surfaces to each other; and
an inlet into the volume and an outlet out of the volume, so that a fluid can flow from the inlet to the outlet through the volume, thereby absorbing heat from or discharging heat to the photovoltaic panel and/or the surroundings through the first main surface,
wherein at least one of the first main surface and the second main surface comprises a plastic sealing layer, and that the first and second main surface are connected to each other by melting of the plastic sealing layer.

34. The heating and/or cooling module according to claim 33, wherein the first main surface and the second main surface each comprise a plastic sealing layer, the first and second main surfaces being connected to each other via their sealing layers.

35. The heating and/or cooling module according to claim 33, wherein the connection between the first and second main surface is made along an edge of the first and second main surface, and
wherein optionally the first and second main surface are connected to each other at an outer edge.

36. The heating and/or cooling module according to the claim 33, wherein the 3D-textile core is provided with a through opening extending through the first and second main surface for admitting an element, thereby defining an inner edge in the first and second main surface, wherein the first and second main surface are connected to each other at the inner edge.

37. The heating and/or cooling module according to claim 33, wherein the plastic comprises a thermoplastic; and
wherein optionally the plastic is thermoplastic polyurethane.

38. The heating and/or cooling module according to claim 33, wherein at least one of the inlet and the outlet is arranged in one of the first and second main surface; and
optionally further comprising an adapter connected to the inlet and/or outlet, the adapter being configured for connecting a conduit thereto; and
optionally further comprising multiple inlets or outlets and at least one rigid flow element comprising the adapter and connecting the adapter to multiple inlets or outlets respectively,
wherein optionally the flow element is a solid component with a channel defined therein; or
wherein the flow element is a hollow profile, and
wherein optionally the hollow profile comprises at least one hollow protrusion extending through the inlet or outlet.

39. The heating and/or cooling module according to claim 33, wherein at least one of the first and second main surface comprises a textile layer and a coating forming the sealing layer, wherein optionally the coating layer protrudes at least partly into the textile layer.

40. The heating and/or cooling module according to claim 39, wherein the coating layer is water impermeable.

41. The heating and/or cooling module according to claim 33, wherein the first and second main surface are connected directly to each other, optionally by their respective sealing layers.

42. The heating and/or cooling module according to claim 33, wherein at least an end zone of a sealing layer of at least one of the first main surface and the second main surface extends towards the other of the first main surface and the second main surface.

43. The heating and/or cooling module according to claim 39, having the at least one end zone extending towards the other of the first main surface and the second main surface, wherein the sealing layer of the at least one of the first main surface and the second main surface extending towards the other of the first main surface and the second main surface has an overlength with respect to the textile layer of its respective main surface.

44. The heating and/or cooling module according to claim 33, further comprising a strip of plastic between the sealing layers of the first and second main surface, connecting the first and second main surface to each other.

45. The heating and/or cooling module according to claim 44, wherein at least some piles run through the strip.

46. The heating and/or cooling module according to claim 33, further comprising two flanges arranged on the outsides of the first and second main surfaces along the edge, the two flanges being interconnected; and
wherein optionally the two flanges extend from a conduit extending along the edge;
and/or
wherein optionally the two flanges are part of a single profile,
wherein optionally the profile is a U- or V-shaped profile; and/or
wherein optionally the profile comprises a flexible or a rigid polymer.

47. The heating and/or cooling module according to claim 33, wherein the heating and/or cooling module comprises a first edge zone along which the first and second main surface are connected, and a second edge zone along which the first and second main surface are connected.

48. The heating and/or cooling module according to claim 47, wherein the first and second main surfaces are substantially rectangular, and wherein the first and second edge zones are oriented substantially perpendicular to each other.

49. The heating and/or cooling module according to claim 33, wherein the first main surface and/or the second main surface comprises a woven, knitted or non-woven textile.

50. A method of manufacturing a heating and/or cooling module for a photovoltaic panel, which is arrangeable on a back of the photovoltaic panel, the method comprising:
a) providing a 3D-textile having a first main surface and a second main surface extending substantially parallel to the first main surface at a distance thereof, and a plurality of piles attaching the first and second main surfaces to each other, at least one of the first main surface and the second main surface comprising a sealing layer;
b) performing a sealing step so that the two main surfaces enclose a volume, comprising the steps of:
b1) heating the sealing layer of the at least one of the first main surface and the second main surface, and
b2) pressing the first main surface and the second main surface towards each other at the location of the sealing layer;
wherein optionally the steps b1) and b2) are carried out simultaneously; and
c) providing an inlet and an outlet into the volume.

51. The method according to claim 50, wherein the first and second main surface are provided with a coating, and wherein in step b) the respective coatings are used to directly attach the first and second main surfaces together.

52. A photovoltaic panel, provided with a heating and/or cooling module according to claim 33, attached to the back of the photovoltaic panel.
